(19) United States
(12) Patent Application Publication
(10) Pub. No.: US 2025/0253670 A1
(43) Pub. Date: Aug. 7, 2025

(54) Method for Feeding Electrical Power into an Electrical Supply Network Using a Wind Turbine

(71) Applicant: Wobben Properties GmbH, Aurich (DE)

(72) Inventors: Kaveh MALEKIAN BOROUJENI, Bremen (DE); Kai BUSKER, Großefehn (DE)

(73) Assignee: Wobben Properties GmbH, Aurich (DE)

(21) Appl. No.: 18/999,420

(22) Filed: Dec. 23, 2024

(30) Foreign Application Priority Data
Dec. 28, 2023 (EP) 23220516.1

(51) Int. Cl. H02J 3/40; H02J 3/00; H02J 3/38

(52) U.S. Cl. CPC H02J 3/40; H02J 3/001; H02J 3/381; H02J 2300/28

(57) ABSTRACT

The disclosure relates to a method for feeding electric power into an electrical supply grid having a mains voltage with a mains frequency using an infeed unit. The method comprises detecting the mains frequency and forwarding the detected mains frequency as frequency measurement signal, filtering the frequency measurement signal into a frequency filter signal by means of a filtering device with low-pass behaviour, determining a frequency-dependent set-point power portion depending on the frequency filter signal, and feeding in electric power depending on the frequency-dependent set-point power portion, wherein to filter the frequency measurement signal by means of the filtering device with low-pass behaviour, at least one first and one second filtering function with low-pass behaviour with characteristic first or second low-pass time constants are used, and the first and second filtering function are entirely or partially interchangeable using at least one of a first or second weighting factor.

### BACKGROUND

The present disclosure relates to a method for feeding electric power into an electrical supply grid via an infeed unit, and more specifically via a wind power installation or a wind farm. The present disclosure additionally relates to a corresponding infeed unit, for example a corresponding wind power installation or a corresponding wind farm.

Wind power installations are known, they generate electric power from wind and feed this power into an electrical supply grid. In addition to the provision of the energy, wind power installations in this case often also have to cope with a task of supporting the grid. Wind power installations should at least operate in a manner that is as supportive as possible to the grid.

In the case of frequency-converter-based infeed technologies, which are also termed type 2 installations which operate in a grid-tracking or grid-supporting manner, the contribution to frequency stability is realized in that first the frequency is ascertained and based on that an active power set-point value is determined by a controller and a P(f) characteristic curve. This active power set-point value is then forwarded to an active power control system of the wind power installation, which in this respect acts as actuator, and realized.

It is to be noted here that delays and elements with limited dynamics exist at various points in such a controlled system. In particular, the active power set-point value may be calculated in a central farm control unit which in this case has a delay in determining frequency, because it uses a discrete Fourier transform (DFT) for example, and also the controller, which determines the active power set-point value from the frequency, may also have dynamics. Furthermore, the communication between the central farm control unit and the wind power installation, to which the active power set-point value is transferred, may also include a delay. Further delays may occur at the wind power installation, on the one hand due to a delayed receipt of the signal transmitted by the central farm control unit and on the other hand owing to the dynamics of the active power control.

These delays and limiting dynamics lead to a delayed active power reaction to a frequency disturbance. In grids with a high proportion of grid-tracking or grid-supporting infeed technologies, this active power reaction will influence the frequency response on the grid. Therefore, a closed control loop is created, because the frequency in the grid that is influenced in this manner is fed back, detected and used in the central farm control for a frequency-dependent active power set-point value. Such delayed active power reactions may as a result cause frequency oscillations in weakly damped grids. A weakly damped grid in this case is one in which a frequency oscillation does not decay asymptotically. In particular, a weakly damped grid is one in which a frequency jump decays with at least one overshoot, whereas a strongly damped grid is one in which no overshoot of the frequency occurs in the event of a frequency jump.

It may also be that existing feeders, particularly wind power installations, have no or no significant damping behaviour for such a frequency-dependent active power infeed.

In a signal flow of this type, a low-pass filter may be provided, in order to filter a frequency change before an active power set-point value is specified depending on the frequency and thus on a changed frequency. A low-pass filter of this type may however be undesirable in the case of a grid fault, as it may lead to too large a delay.

### SUMMARY

The present disclosure is therefore based on the object of addressing at least one of the above-mentioned problems. For example, the present disclosure presents a solution, in which the excitation of oscillations is avoided during the specification of a frequency-dependent active power for feeding into the electrical supply grid even in the case of weakly damped electrical supply grids, whilst at the same time, a fast reaction to a frequency event, for example to a grid fault, is enabled. At least, an alternative to hitherto known solutions should be proposed.

According to the present disclosure, a method according to Claim 1 is proposed. A method of this type therefore relates to the feeding of electric power into an electrical supply grid which has a mains voltage with a mains frequency. Feeding-in takes place by means of an infeed unit (for example, by means of a wind power installation or a wind farm). To this end, the mains frequency is detected and forwarded as frequency measurement signal. The frequency measurement signal is filtered into a frequency filter signal by means of a filtering device with low-pass behaviour and a frequency-dependent set-point power portion is determined depending on this frequency filter signal.

A frequency-dependent power portion is therefore determined, which should accordingly also be fed in. In one example, a further active power portion is specified independently of the frequency, particularly depending on an available power, that is to say in the case of a wind power installation or a wind farm depending on available wind power or in accordance with a specification. This portion may also be constant in sections, for example if the underlying primary energy, such as wind power in the example mentioned, permits this. This frequency-dependent set-point power portion is added to this active power portion which does not depend on the/a frequency and can also be termed the fundamental active power portion. The result then is an active power set-point value of the active power to be fed in as a whole.

In this respect, electric power is then fed in depending on the frequency-dependent set-point power portion, that is to say together with the power that is not dependent on the frequency and is added as fundamental power portion.

To filter the frequency measurement signal by means of the filtering device with low-pass behaviour, at least one first and one second filtering function with low-pass behaviour with characteristic first or second low-pass time constant are used. The filtering device therefore has at least two filtering functions which differ in terms of their low-pass time constant. Both filtering functions, or if appropriate even more filtering functions, therefore have low-pass behaviour, that is to say filter out high frequencies, but—expressed in simple terms—have different speeds.

In addition, it is provided that it is possible to change between the first and second filtering functions, if appropriate between yet further functions, entirely or partially. In one example, this can take place via a first and/or second weighting factor.

In principle, this can be realized such that these two filtering functions, so as to stay with this simplest variant, essentially operate in parallel. Both filtering functions therefore filter the frequency measurement signal and can each output a filtered measurement signal that has thus been filtered differently. Therefore, not only are two differently filtered frequency signals present, rather there are also two different delays present as a result. Expressed in simplified terms, the filtered frequency signal which was filtered with the filtering function with the larger low-pass time constant is more substantially delayed, that is to say is slower, as it were, than the other filtered frequency signal.

Then, there are two filtered frequency signals present, which can be superimposed again. However, it is provided to weight these filtered frequency signals prior to superimposing. In the simplest case, one weighting factor can have the value 0 and the other can have the value 1. In this case only one of the two filtered frequency signals is forwarded. These two weighting factors can change their value, however, and in the other extreme case, the first weighting factor is then 1 and the second is 0. In this case, it is no longer the first, but rather the second filtered frequency signal that is forwarded.

By means of these weighting factors, both filtered frequency signals can be combined, however. In one example, it is possible by continuously raising the one weighting factor and continuously lowering the other weighting factor to produce a transition from one filtered frequency signal to the other filtered frequency signal.

In one example, it can be provided that due to the weighting factors, normally only the filtering function with the faster low-pass behaviour, that is to say with the smaller time constant, is active. If a fault occurs, it is then possible to react to this fast. The fast filtering function therefore remains active initially, but is then supplanted by the slow filtering function. It is ensured as a result that a possible excitation of oscillations due to this grid fault case is rather damped by the slower filtering function, at least that this is prevented from leading to an oscillation.

If the situation has stabilized, it is possible to change back to the fast filtering function again, as a new fault could occur, which should be reacted to fast.

In principle, at least two weighting factors are provided, namely one for each filtering function. It may however be sufficient if a single weighting factor is used, if this weighting factor is applied directly for the one filtering function and this weighting factor is applied for the other filtering function in that it is first subtracted from 1.

According to one aspect, it is proposed that the first and second filtering functions operate in parallel to one another, are weighted with the first or second weighting factor and it is possible to change between the filtering functions by changing the weighting factors. The principle that has already been described above is therefore realized by means of this aspect. The basic setting of a fast low-pass filter or a fast low-pass filtering function can therefore be realized by means of the two weighting factors.

This fast low-pass filter can therefore be provided permanently. In a fault case, it is possible to change to the other filtering function by adjusting the weighting factors in that the one is lowered from 1 to 0 and the other is raised from 0 to 1. Later, when the grid has settled, it is possible to change back again in that the one weighting factor is set to 1 again and the other is set to 0 again.

This adjustment can take place in a continuous and coordinated manner. For example, the adjustment may take place by means of corresponding ramps. Preferably, the two weighting factors, if they fundamentally change between 0 and 1, are chosen such and changed such that their sum is always 1. This avoids the amplitude of the frequency filter signal being changed due to the weighting factors.

In this respect that is, it is proposed that the frequency filter signal is the superimposition of the two weighted outputs of the two filtering functions. The outputs of the two filtering functions can therefore be added up after the weighting factor.

According to one aspect, it is proposed that the first and second filtering functions filter the frequency measurement signal into a first or second filter signal and the first and second filter signals, weighted with the first or second weighting factor, are added up to form the frequency filter signal or a part thereof, wherein the first and second weighting factors are changeable.

The previously explained functionality can be realized as a result of this. The two filtering functions operate in parallel, so that two partial filter signals emerge from the detected frequency signal. These have the aforementioned different properties, for example, the one partial filter signal can be detected faster than the other or a frequency change. For example, a frequency disturbance, can be detected faster in the one filter signal than in the other.

The two partial filter signals can then be added to one another, which can also be considered as superimposition, wherein due to the two weighting factors, on the one hand it is realized that the desired filtering function is acting or is present in each case. On the other hand, it is ensured that the two partial filter signals that are superimposed, that is to say that are added up, lead to the same amplitude, after the weighting with their respective weighting factor, that the frequency measurement signal had prior to the filtering or that the frequency measurement signal would have after one of the two filters without weighting factor or weighting factor with the value 1.

According to one aspect, it is proposed that the first and the second weighting factors for weighting the first or second filtering function are only changed such that the sum thereof remains constant (e.g., is 1). As a result, as has already been explained previously, it is possible to ensure that changing the weighting factors does not influence the frequency filter signal, which is composed of the first and second partial filter signals by means of addition, in terms of its amplitude. If the sum of the two weighting factors is 1, the amplitude of the frequency filter signal remains essentially the same, that is to say behaves as if only one low-pass filter without a weighting factor were used.

According to one aspect, it is proposed that the second low-pass time constant is chosen depending on a system natural frequency of the electrical supply grid that is coupled with the infeed unit, for example such that the second low-pass time constant is chosen to be larger than a reciprocal of the system natural frequency.

It is therefore proposed to take account of such a system natural frequency and to detect the system natural frequency for that. Such a system natural frequency is therefore a natural frequency of the electrical supply grid that is coupled with the infeed unit. Therefore, it is proposed in one example, for the control of the frequency-dependent active power or active power specification, initially to use no filter or a fixed, predetermined filter.

The natural frequency can be identified by system excitation, for example by means of a step response. For this, a jump in the power can be specified for a wind power installation and then the reaction of the mains frequency and/or the resulting set-point power can be observed. One option for implementing this may consist in the set-point power of the wind power installation being lowered to an artificial value and then, after the system has settled, suddenly increasing this set-point power value to the power value which the central farm control would specify on the basis of the current frequency. At the moment when the set-point power at the input of the wind power installation has therefore jumped to the value which the central farm control has actually already specified all along, the hitherto interrupted signal connection from the central farm control to the wind power installation, via which the frequency-dependent power set-point value is transferred, can then be activated again.

As a result, it is possible to specify a jump for an existing system without a physical variable in the grid, for example the mains frequency having to be changed, however.

Alternatively, a frequency measurement value can also be manipulated, e.g. lowered, artificially at the input of the central farm control and then suddenly be increased to the current value in order then to input the current frequency value as measurement, however.

Alternatively, a simulation can also be carried out, in which for example the mains frequency is actually changed suddenly. For example, in the case of a simulation, diverse other options are available for frequency analysis, including an analytical frequency analysis if the properties of all elements are known.

In one example, it is provided that a simulation circuit is built, in which the grid is formed by a phase shifter and a variable load. The phase shifter can in one example be designed as a synchronous motor which is operated in an idling manner. Current and voltage are then detected and further used in the central farm control unit. In one example, the frequency is determined therefrom and a frequency-dependent set-point power value is determined depending thereon and passed to a wind power installation which correspondingly has a power output which feeds into this test grid. The entire test set-up can therefore be constructed from the central farm control unit and the wind power installation, which is connected to the test grid and feeds into the same, with the aforementioned variable load and the aforementioned phase shifter in addition.

Starting from a system natural frequency which is determined in such a manner, it is proposed that the second low-pass time constant is chosen to be larger than a reciprocal of the system natural frequency. This initially has the effect that a same natural frequency in the filter and in the rest of the system is avoided, but in one example due to the larger time constant, that is to say the slower behaviour of the second low-pass filter, a damped behaviour can be achieved.

It is provided in one example that the second low-pass filter is used or is at least dominant if a grid fault has occurred, which is explained further in detail below. If a grid fault has occurred, the system tends to oscillate, and for this case the second low-pass filter is provided with a second low-pass time constant which in principle leads to a slower behaviour of the low-pass filter than the system has owing to its system natural frequency.

It is therefore provided as a result that the second low-pass filter is used, in one example is dominant, while oscillation in the electrical supply grid can occur. It is precisely in this case that the damping action of such a low-pass filter comes into its own, as too fast a low-pass filter should then be prevented from supporting or in any case not preventing an oscillation. The second slow low-pass filter, which is namely slow with respect to the system property or system natural frequency, can prevent such an oscillation and at least does not excite it further, so that it can at least decay.

According to one aspect, it is proposed that the first and second low-pass time constants are changeable for adapting to a system change and/or changed system requirement, wherein a restriction is provided such that a change only takes place such that the first low-pass time constant is smaller than the second low-pass time constant.

It should therefore be maintained in any case that the two low-pass filters have a particular task, namely that the first low-pass filter is fast and can react fast or permits a fast reaction in the event of a grid fault, whereas the second low-pass filter is slower and following the occurrence of a grid fault, when the system may still be labile and/or may tend to oscillate, acts in a calming manner on oscillations that are present or may potentially develop.

According to one aspect, it is proposed that the first and second low-pass time constants are changeable for adapting to a system change and/or changed system requirement, wherein a restriction is provided such that a change only takes place such that the first low-pass time constant is smaller than the second low-pass time constant.

It should therefore be maintained in any case that the two low-pass filters have a particular task, namely that the first low-pass filter is fast and can react fast or permits a fast reaction in the event of a grid fault, whereas the second low-pass filter is slower and following the occurrence of a grid fault, when the system may still be labile and/or may tend to oscillate, acts in a calming manner on oscillations that are present or may potentially develop.

As the low-pass filter may be implemented in a process computer, a time constant or an amplification factor of the low-pass filter can readily be changed. Programming can be used, in which both filter constants can be changed simultaneously, whilst it is possible to comply with boundary conditions. One such boundary condition is that the first low-pass time constant is smaller than the second. The boundary condition can also be configured such that the first and second low-pass time constants have a relationship to one another, the second for example has ten-times the value of the first.

According to one aspect, it is proposed that the first low-pass time constant is smaller than the second low-pass time constant and in stable operation, when no grid fault has been identified or, following a grid fault, a stable state is reached, the first weighting factor is chosen to be greater than the second. For example, the first weighting factor is chosen to be 1 and the second to be 0. In such stable operation, the first low-pass filter and therefore the faster low-pass filter is therefore actually engaged substantially or exclusively. Therefore, frequency changes of the mains frequency can be detected and processed further fast, in one example converted into a frequency-dependent power set-point value.

Furthermore, it is proposed that, in fault-case operation, following identification of a grid fault, for example after a transition time has elapsed, the first weighting factor is reduced and the second weighting factor is increased. In one example, it is proposed that the first weighting factor is reduced to a small value in the range of 5% to 20% and the second weighting factor is increased to a large value correspondingly in the range of 80% to 95%. This fault-case operation therefore follows stable operation when a grid fault is identified.

Preferably however, it does not follow immediately, but rather only after a transition time has elapsed. This transition time may be in the range of 0.02 s to 10 s, or more specifically in one example, in the range of 0.1 s to 1 s. In one example, in fault-case operation, the first weighting factor is therefore reduced and brought to 0, whilst the second is increased and is brought to 1. After this change is complete, the second, that is slower low-pass filter is therefore dominantly or exclusively active. As a result, it is ensured that in this fault-case operation, oscillations of the electrical supply grid are prevented or at least are not excited further.

In addition, it was discovered however that at the start of or prior to this fault-case operation, namely when the grid fault has just been identified, a fast low-pass filter is still desirable so that the identified fault is transferred faster or it is identified faster overall. In addition, it was discovered that a feared oscillation of the electrical supply grid in combination with the infeed unit, such as a wind power installation or a wind farm, takes some time, so fault-case operation does not have to be implemented in full immediately. After a time of 10 s however, the fault-case operation should then be effective.

It is additionally proposed that following the fault-case operation, for example after a safety period has elapsed and/or after a stability criterion has been fulfilled, a return to stable operation is carried out in that the first weighting factor is increased again, for example to 1, and the second weighting factor is reduced again, for example to 0.

Here, it is proposed in one example that in fault-case operation, the influence of the fast low-pass filter, which is weighted by the weighting factor W1, be reduced, but not entirely. Therefore, in fault-case operation, the first weighting factor W1 is not reduced to 0, but rather to a small value, for example in the range between 5% and 20%, preferably approximately 10%. As a result, it is still possible even in fault-case operation to ensure that a further grid event, for example a further grid fault, is transferred fast by means of this fast low-pass filter, even if it is with a smaller amplitude.

In this case, a small value or a large value for the weighting function is to be understood in relation to a range of 0% to 100% or 0 to 1. The smallest value is therefore 0 and the largest is 1. The first and second weighting factors are chosen such in this case that their sum is 100%, that is to say if for example W1=5% was chosen, W2=95% is chosen.

For stable operation however, it is proposed according to one aspect that here the second weighting factor W2, which weights the slow low-pass filter, can fall completely to 0. Here, it was discovered that in stable operation, the slow low-pass filter is not required and its weighting can therefore fall completely to 0.

The safety period can be in the range from 1 min to 10 min.

A safety period of this type is provided so that it is possible to ensure that the electrical supply grid has calmed down again from the grid fault in order to avoid returning too fast to stable operation in which the second, that is to say slower low-pass filter is no longer active or at least has a lower dominance than the first, fast low-pass filter. The first low-pass filter is however not or less suitable for preventing grid oscillations or at least not exciting the oscillation, so stable operation should only be chosen again when such oscillations in the grid are no longer to be expected.

A stability criterion can also be used as a basis, which is to be fulfilled before there is a return to stable operation. The criterion may for example examine a fluctuation of the mains frequency or a fluctuation of the mains voltage and be fulfilled if such a mains-frequency fluctuation or mains-voltage fluctuation has fallen below a limit value which in one example is in the range from 1 to 5%. The amplitude of the mains frequency or mains voltage therefore fulfils this stability criterion if the mains frequency or mains voltage fluctuates by less than 1% or 5%. Other criteria also come into consideration, however.

One such stability criterion can be combined with the elapse of a safety period in that the stability criterion is to be fulfilled followed by an end of the safety period.

According to one aspect, it is proposed that if the first low-pass time constant is smaller than the second low-pass time constant, which can be assumed for all described aspects, in fault-case operation following the identification of the grid fault, for example after the elapse of the transition time, the first weighting factor is reduced continuously, using a time ramp function, and the second weighting factor is increased synchronously with the same, such that the first weighting factor is reduced to a small value of 5% to 20% and the second weighting factor is increased to a large value in the range from 80% to 95%. Here also, the first and second weighting factors are chosen such in this case that their sum is 100%, that is to say if for example W1=5% was chosen, W2=95% is chosen. The reason for preferably not lowering the first weighting factor to 0 completely has already been described above, namely it should moreover continue to be ensured that a further grid event or grid fault is transferred fast via the fast low-pass filter.

Therefore, in grid-fault operation and therefore following the identification of the grid fault, a continuous transition takes place from stable operation to the part of fault-case operation in which only the second low-pass function is still active, at least is dominant. In addition, the first weighting factor can be raised by means of a time ramp function and, corresponding to that, the second weighting factor can be reduced with a correspondingly falling ramp.

Here, it was discovered in one example that by means of such an increase of the one weighting factor synchronously to the reduction of the second weighting factor, such as by means of ramp functions, two existing filtering functions can be swapped for one another continuously very well. In one example, it was discovered that such a transition from one to another filtering function is better suited than changing a time constant of a filtering function instead.

Here, it was discovered in one example that even in this transition phase, both filtering functions function very normally. In one example, no misgivings need exist that the change of a filtering function could lead to an undesirable result, for example to an instability. In one example, no filtering function needs to be examined for its behaviour for such a transition if its time constant should be changed continuously during continuous operation.

In addition or alternatively, it is proposed that following the fault-case operation, such as after a safety period has elapsed and/or after a stability criterion has been fulfilled, a return to stable operation is started and in one example carried out in that the first weighting factor is increased again continuously, using a time ramp function (e.g., increased to 1), and the second weighting factor is reduced synchronously with that (e.g., reduced to 0). Here also, a transition from fault-case operation to stable operation can be realized by a continuous transition in that the two weighting factors are simply changed by means of opposing ramps from their setting in fault-case operation to the setting in stable operation. Stable operation may also be referred to synonymously as operation that is stable.

It is however also the case that the return to stable operation is started, but stable operation is not achieved, because a further grid event, such as a grid fault, occurs or other instability is present, for example an island-grid situation has occurred, before stable operation is reached. The consideration then is that the weighting factors have not returned completely to initial values. For example, the first weighting factor may only be increased to a value of 50% to 70% and the second may be reduced to a value of 30% to 50%.

According to one aspect, it is proposed that the infeed unit is designed as a wind farm having a plurality of wind power installations and the filtering of the frequency measurement signal by means of the filtering device and the determination of the frequency-dependent set-point power portion take place in a central farm control unit, and a set-point power value that is to be fed in is transferred to the wind power installations depending on the frequency-dependent set-point power portion, wherein in one example the set-point power value is formed as the sum of the frequency-dependent set-point power portion, possibly following further conversion, and a set-point fundamental power value which can be predetermined.

Thus, the filtering and with that also the use of the at least two filtering functions, such as low-pass filters, take place in the central farm control unit. There, the frequency measurement signal is therefore filtered so that, depending on the weighting factor, a faster or slower low-pass filter carries out the filtering and the result then is the frequency filter signal, depending on which the frequency-dependent set-point power portion is determined.

For feeding-in, it is proposed, however, to determine and to feed in not only a power corresponding to this set-point power portion, but rather additionally to supplement a fixed value as it were. A fixed value of this type may be the predeterminable set-point fundamental power value, which may also be referred to synonymously as set-point fundamental power portion. It can be determined according to a grid requirement or available wind conditions, that is to say available wind power. In this respect, the frequency-dependent set-point power portion and therefore following conversion a frequency-dependent power portion, namely active power portion, can be added to this fundamental power value. The power that is fed in can then fluctuate about this set-point fundamental power value and thus in the case of ideal conversion about the fundamental power value.

In one example, when the mains frequency assumes a nominal value, the frequency-dependent set-point power portion is 0. In one example, it is provided that it originates if frequency changes occur if they are significant, that is to say deviate from the nominal frequency value by a dead band. Such a dead band may be in the range from 0.2 to 0.8 Hz, or in more specifically in some examples, in the range of 0.3 to 0.6 Hz.

The proposed filtering device therefore uses the two filtering functions or the two low-pass filters and can therefore transfer a frequency-dependent set-point power portion to the wind power installations, which no longer passes on oscillations of the mains frequency to the wind power installations or at least passes them on to a reduced extent.

The frequency-dependent set-point power portion and/or the set-point power value that is to be fed in and/or the predeterminable set-point fundamental power value can also be transferred to the wind power installations as percentage values. These percentage values may relate to a nominal farm power and/or a nominal installation power. That is then the same reference if the sum of all nominal powers of the wind power installations in the farm correspond to the nominal power of the farm, which should usually be the case.

According to one aspect, it is proposed that the frequency-dependent set-point power portion is limited by means of a limiting function to a power limit in order to form a limited set-point portion and the limited set-point portion is added to the set-point fundamental power value in order to form the set-point power value for the power to be fed in overall. This set-point power value for the power that is to be fed in overall can also be referred to synonymously as total set-point power value.

Thus, it is proposed that a limit be introduced, but which in this case is applied to the frequency-dependent set-point power portion. As a result, it is ensured that in spite of limiting, a frequency-dependent power portion can be realized. If a power limit is specified for the power that is to be fed in overall, that is to say the total power, or for the total set-point power value, this limit could already be reached without applying the frequency-dependent power portion, as a result of which a frequency-dependent application of power, at least its positive portion, would have no effect.

In one example, the set-point fundamental power value is chosen such that it is below an available power by the power limit, e.g., below a wind power if the generation unit is a wind power installation or a wind farm. The set-point fundamental power value is therefore correspondingly reduced. As a result, it can be ensured that the limited frequency-dependent set-point power portion can in any case still be applied to the set-point fundamental power value, because it is only as a result of this that at maximum the limit, which is specified by the available power, is reached.

According to one aspect, it is proposed that
to detect the mains frequency, the mains voltage is detected (or in some examples measured), and the mains frequency is determined from the mains voltage, such that
a space phasor \vec{u} is determined from the measured three-phase mains voltage, using the formula

$$\vec{u} = [ {u}_{1} + {u}_{2} exp ( j \frac{2}{3} π ) + {u}_{3} exp ( j \frac{4}{3} π ) ] ,$$

with u₁, u₂ and u₃ in each case as an instantaneous value, such as as an instantaneous measured value of a first, second or third mains voltage phase,
the determination of the space phasor \vec{u} is repeated over time, for example in further sampling steps, and
the detected mains frequency is determined from a change over time of a phase angle of the space phasor \vec{u}.

According to one aspect, it is proposed that the first and second filtering functions are in each case realized by one of the following filtering units.

The filtering unit can be realized as a PT1 element, that is to say as a first-order delay element. This ensures that a filtering unit of this type does not have an overshooting behaviour. The PT1 element can be represented in the Laplace domain by the following transfer function G(s) which specifies the relationship between an output signal Y(s) and an input signal U(s):

$$G ( s ) = \frac{Y ( s )}{U ( s )} = \frac{K}{1 + T \cdot s}$$

In the formula, K forms an amplification factor and T forms a time constant, that is to say the filter time constant.

The filtering unit can also be realized as a PT2 element with a damping ratio D>1. A PT2 element of this type can be represented in the Laplace domain by the following equation:

$$G ( s ) = \frac{Y ( s )}{U ( s )} = \frac{K}{{T}^{2} \cdot {s}^{2} + 2 \cdot D \cdot T \cdot s + 1}$$

In the equation, K refers to an amplification factor which—as also in the case of a PT1 element—can be chosen as 1. Furthermore, T refers to a filter time constant and D is the damping ratio. If D is chosen to be larger than 1, a step response results without overshoot with an asymptotic behaviour. Also, a good low-pass behaviour with damping effect can be achieved.

The filtering unit can also be realized as an averaging unit for carrying out an ongoing averaging. An averaging of this type can, in one example, be formed as a window function which uses a sliding window in which all values of a time interval with a predetermined length are recorded and the average value is formed from them. In the next sampling step, this window shifts as it were by one value further and the average value is formed over the sampled values, of which a new one has been added and an old one has been dropped. An averaging of this type and thus the corresponding averaging unit likewise has a property that no overshoots develop, so it is likewise well-suited for damping.

The filtering unit can be realized by a filter which has a behaviour similar to a PT1 element or a PT2 element with a damping ratio D>1. In principle, it was discovered that a PT1 behaviour or PT2 behaviour is very advantageous, but does not absolutely have to be realized precisely by a PT1 element or PT2 element with damping ratio D>1, rather realization by a filtering function with similar properties can lead to similar results. In one example however, a corresponding damping behaviour should be present.

The filtering unit can also be realized as a filtering element with a specifiable time constant and with a step response without overshoot. Due to the specifiable time constant, the dynamics and therefore also a low-pass time constant can be adjusted; it is therefore also possible to adjust how fast the filtering element is. It is also designed such that it reacts to a step response without overshoot, as is also the case for the PT2 element, if the damping ratio D is chosen to be greater than 1.

According to one aspect, it is proposed that a wind farm with a farm control unit having a farm power controller and with a plurality of wind power installations is used for feeding in the electric power, which wind farm has a cascade controller with three control loops.

These three control loops are an inner control loop, in which each of the wind power installations adjusts an output power to an installation set-point power specified by the farm power controller, a middle control loop, in which the farm power controller deter-mines the installation set-point power as control variable depending on a comparison between a farm set-point power value and a farm actual power value and transfers it to the wind power installations as installation set-point power, and an outer control loop, in which, depending on the detected mains frequency, the set-point power portion and, depending on that, the farm set-point power value is determined as control variable and transferred to the farm power controller.

Therefore, these three control loops are present and it was discovered in one example here that the determination of the farm set-point power value depending on the mains frequency is likewise to be considered as part of a control loop, namely the outer control loop. This is based on the consideration that ultimately this outer control loop has an influence on the power that is fed in and therefore influence on the resulting mains frequency. This resulting mains frequency is used for determining the farm set-point power value and thus this farm set-point power value depends on the mains frequency which it itself influences. Therefore, feedback is present in the sense of control technology, so in fact, this determination of the farm set-point power can be considered as part of an outer control loop.

Building on this, it is proposed that the filtering device with low-pass behaviour for filtering the frequency measurement signal is part of the outer control loop. As a result, the time response of the outer control loop can be influenced by means of this filtering device.

In addition, it is further proposed that the second low-pass time constant, if this is great-er than the first low-pass time constant, is chosen such that the outer control loop has a slower time response than the middle and/or inner control loop if the second weighting factor is chosen to be 1 or is at least dominant. The second weighting factor is considered as dominant if it is in the range from 80% to 95%. If it has the value 1, it is of course also dominant. That the second weighting factor is dominant in one example means that the second low-pass filter, which is activated by the second weighting factor, is dominant, that is compared to the first low-pass filter, due to such a large weighting factor.

This is therefore based on the situation, which has already been described previously, that the second low-pass time constant is greater than the first, so the second filtering function is the slower of the two. By means of the second weighting factor, this can be set to be dominant in principle or solely active. If the second weighting factor is 1, only this second filtering function is therefore acting.

This is provided in one example if the electrical supply grid tends to oscillate after a grid fault, that is to say if the grid is not yet operating in a completely stable manner or at least an oscillation may be expected. In this case, the second filtering function is there-fore active and the second low-pass time constant, that is to say the time constant of the active filter, is then chosen such that the outer control loop is slower than the middle and/or inner control loop.

In principle, it is desirable in the case of a cascade controller that the control loops always get faster from the outside inwards, that is to say that the outer control loop is the slowest. Such conditions are not always met however, as they do not always have to be met. In one example, they have not hitherto been met for the outer control loop, as it was assumed that only a small influence on the mains frequency is due to this outer control loop.

In principle, the frequency-dependent determination of the farm power was considered more as a control in this respect. Therefore, in one example, small time constants were advantageous so that an input variable of such an assumed control, that is the mains frequency here, had influenced the farm power to be determined as fast as possible.

Then it was discovered however that the outer control loop should be considered as such and it also has a dynamic behaviour that is to be taken into account.

In order then to obtain the outer control loop correspondingly slowly, it is proposed to adapt the second low-pass time constant accordingly, therefore the outer control loop is correspondingly slowed by the second filtering function.

In one example, it is provided that the first low-pass time constant is chosen such that the outer control loop has no slower time response than the middle and/or inner control loop if the first weighting factor is chosen to be 1, or is at least dominant compared to the second weighting factor, for example has a value in the range from 80% to 95%. This is based on the discovery that a fast reaction of the frequency-dependent power control continues to be desirable. This should only be provided however if no oscillation problems are present due to a grid fault or following a grid fault. For stable grid conditions outside of such a grid fault or behaviour following such a grid fault, it is provided, in one example, to use the first filtering function. This is switched to active or at least dominant in principle by means of the first weighting factor. It was discovered that for this case the condition that the outer control loop should be slower than the middle and/or inner control loop can be disposed of, as there is a stable grid present.

Thus, a solution is proposed, in which the cascade control of the wind farm can exhibit high stability or higher dynamics in a situation-dependent manner.

According to the present disclosure, an infeed unit, for example a wind power installation or a wind farm, is additionally proposed.

According to the present disclosure, an infeed unit, for example a wind power installation or a wind farm, is therefore proposed for feeding electric power into an electrical supply grid having a mains voltage with a mains frequency. The infeed unit is prepared for carrying out a method having the following steps:
detecting the mains frequency and forwarding the detected mains frequency as frequency measurement signal,
filtering the frequency measurement signal into a frequency filter signal by means of a filtering device with low-pass behaviour,
determining a frequency-dependent set-point power portion depending on the frequency filter signal, and
feeding in electric power depending on the frequency-dependent set-point power portion, wherein
to filter the frequency measurement signal by means of the filtering device with low-pass behaviour, at least one first and one second filtering function with low-pass behaviour with characteristic first or second low-pass time constants are used, and
it is possible to change between the first and second filtering functions entirely or partially, for example via a first and/or second weighting factor.

In one example, the infeed unit is prepared for carrying out this method, with the method being implemented on a control device of the infeed unit. For example, in the case of a wind farm, the method can be implemented on a farm control unit, possibly with the implementation of substeps on process computers of the individual wind power installations, which can also be referred to as an installation control.

The infeed unit therefore achieves the advantages as were explained previously for the method and can also be specified accordingly.

According to one aspect, it is proposed that the infeed unit is characterized in that a central control unit is provided. If the infeed unit is a wind farm, a central farm control unit may be provided. The previously explained method according to at least one aspect can be carried out on such a central control unit or central farm control unit.

Thus, it is also proposed that the infeed unit is prepared to carry out a method according to one of the previously explained aspects. In addition, the method can in one example, be implemented on the central control unit or central farm control unit, which are therefore preferably prepared to carry out the method.

According to one aspect, it is provided that the infeed unit
has a wind farm with a farm control unit having a farm power controller and with a plurality of wind power installations for feeding in the electric power, which wind farm has a cascade controller with three control loops, having
an inner control loop, in which each of the wind power installations adjusts an output power to an installation set-point power specified by the farm power controller,
a middle control loop, in which the farm power controller determines the installation set-point power as control variable depending on a comparison between a farm set-point power value and a farm actual power value and transfers it to the wind power installations as installation set-point power, and
an outer control loop, in which, depending on the detected mains frequency, the set-point power portion and, depending on that, the farm set-point power value is determined as control variable and transferred to the farm power controller, wherein
the filtering device with low-pass behaviour for filtering the frequency measurement signal is part of the outer control loop, and
the second low-pass time constant, if it is greater than the first low-pass time constant, is chosen such that the outer control loop has a slower time response than the middle and/or inner control loop if the second weighting factor is chosen to be 1 or is at least dominant compared to the first weighting factor (for example, has a value in the range from 80% to 95%), wherein
the first low-pass time constant is chosen such that the outer control loop has no slower time response than the middle and/or inner control loop if the first weighting factor is chosen to be 1, or is at least dominant compared to the second weighting factor (for example, has a value in the range from 80% to 95%) and/or
the outer control loop, if the filtering function were to be bridged, has no slower time response than the middle and/or inner control loop.

Therefore, the infeed unit is provided as a wind farm which is controlled by a cascade controller with three control loops. For the outer control loop, it is possible by means of the proposed filtering device and the proposed choice of the second low-pass time constant to ensure that the outer control loop operates slowly enough in a demand-dependent manner to make the cascade controller correspondingly stable in the case of a grid fault or a critical time period thereafter, but otherwise to make the cascade con-troller correspondingly fast.

### BRIEF DESCRIPTION OF THE DRAWINGS

In the following, the present disclosure is explained in more detail by way of example on the basis of exemplary embodiments, with reference to the accompanying figures.

FIG. 1 shows a wind power installation in a perspective illustration.

FIG. 2 shows a wind farm in a schematic illustration.

FIG. 3 schematically shows a simplified controlled system of a frequency-dependent power control of a wind farm.

FIG. 4 schematically shows a closed control loop with the simplified controlled system according to FIG. 3.

FIG. 5 schematically shows a simulation arrangement having a fictitious undamped island grid for verifying internal damping of a frequency-dependent power controller.

FIG. 6 schematically shows a control structure of a known frequency-dependent power controller in a farm control unit of a wind farm.

FIG. 7 schematically shows a frequency-dependent power controller with a proposed filtering device for improving the frequency-dependent power controller according to FIG. 6.

FIG. 8 schematically shows a time graph for a change between a first and second low-pass filter of a filtering device in the case of a grid fault.

FIG. 9 schematically shows a cascade controller for a frequency-dependent power control in a wind farm.

### DESCRIPTION

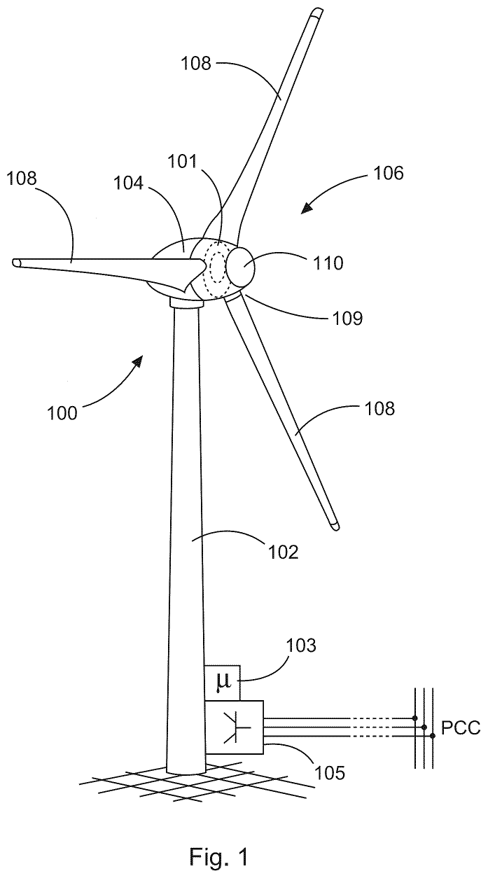

FIG. 1 shows a schematic illustration of a wind power installation according to the present disclosure. The wind power installation 100 has a tower 102 and a nacelle 104 on the tower 102. An aerodynamic rotor 106 having three rotor blades 108 and a spinner 110 is provided at the nacelle 104. The aerodynamic rotor 106 is set rotating by the wind during operation of the wind power installation and thus an electrodynamic rotor or armature of a generator, which is directly or indirectly coupled with the aerodynamic rotor 106, therefore also rotates. The electric generator is arranged in the nacelle 104 and generates electrical energy. The pitch angle of the rotor blades 108 can be changed by pitch motors on the rotor blade roots 109 of the respective rotor blades 108.

The wind power installation 100 in this case has an electric generator 101 which is indicated in the nacelle 104. Electric power can be generated by means of the generator 101. An infeed unit 105 is provided for feeding in electric power, which can be designed as a power inverter in one example. Therefore, a three-phase infeed current and/or a three-phase infeed voltage can be generated according to amplitude, frequency and phase for feeding in at a grid connection point PCC. This can take place directly or else together with further wind power installations in a wind farm. An installation control 103 is provided to control the wind power installation 100 and also the infeed unit 105. The installation control 103 can also contain default values from outside, for example from a central farm control unit.

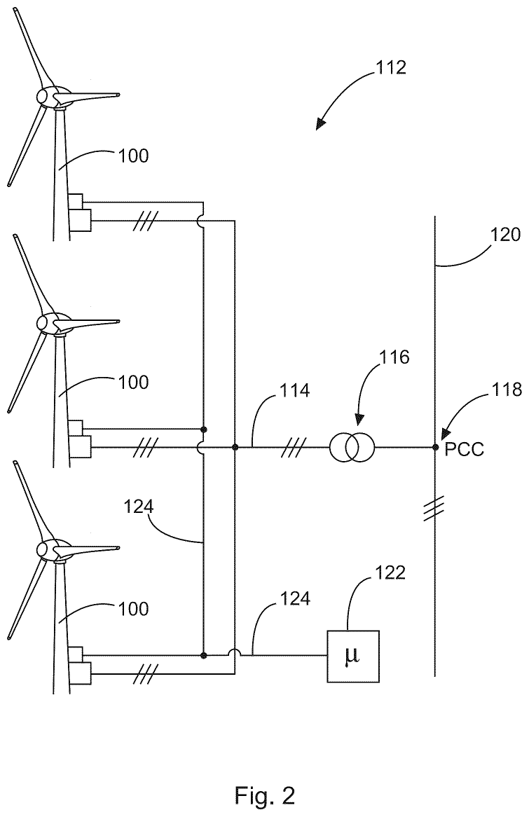

FIG. 2 shows a wind farm 112 with for example three wind power installations 100 which may be the same or different. The three wind power installations 100 are therefore representative for, in principle, an arbitrary number of wind power installations of a wind farm 112. The wind power installations 100 may provide their power, such as the generated current via an electrical farm grid 114. In this case, the respectively generated currents or powers of the individual wind power installations 100 are added up and for the most part a transformer 116 is provided, which steps up the voltage in the farm, in order then to feed it into the supply grid 120 at the infeed point 118, which is also referred to in general terms as PCC. FIG. 2 is only a simplified illustration of a wind farm 112. The farm grid 114 can be configured differently for example, in that a trans-former is also present at the output of each wind power installation 100 for example, to mention just one other exemplary embodiment.

The wind farm 112 additionally has a central farm computer 122 which can also be referred to synonymously as a central farm control or central farm control unit. This can be connected via data lines 124 or wirelessly to the wind power installations 100 in order to exchange data with the wind power installations by means of the same and in one example, to obtain measured values from the wind power installations 100 and transfer control values to the wind power installations 100. In one example, values for an installation set-point power can be transferred by means of the same.

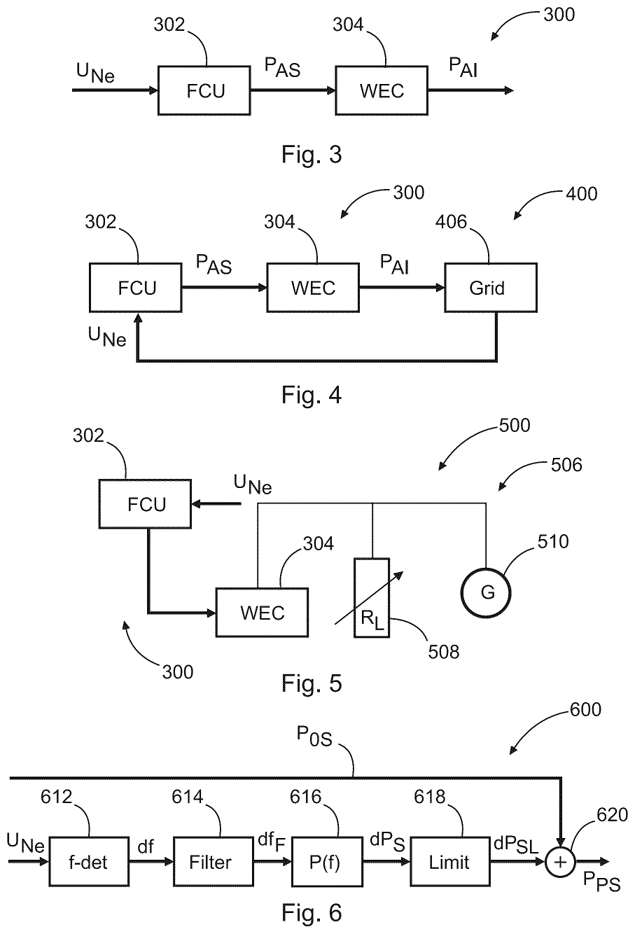

FIG. 3 shows an illustration of a controlled system 300 having a central farm control unit 302 and a wind power installation 304, which is also representative for a plurality of wind power installations that in principle are connected in parallel. A mains voltage UNe forms the input into the central farm control unit 302. A frequency is detected depending on this mains voltage UNe, which can take place for example by means of a discrete Fourier transform (DFT), to mention only one example. A frequency detection of this type may have dynamics and accordingly, a delay.

In addition, an installation set-point power PAS is determined depending on the frequency detected in this manner. This therefore depends on the frequency and can additionally depend on the power that is fed in from the farm overall, which may also be referred to as farm power. In one example, a farm set-point power is determined initially depending on the frequency and this is compared with a farm actual power and, depending on this, the installation set-point power PAS is adapted. All this may also include dynamics and therefore also a delay.

The installation set-point power PAS is then transferred to the respective wind power installation 304. Also the transfer can include a delay. The installation set-point power PAS can be transferred as power values or percentage values.

In the wind power installation, an installation actual power PAI that is fed in is then output and fed-in in accordance with the installation set-point power PAS. Also, this conversion includes dynamics, including dynamics for receiving the set-point values and dynamics for converting the set-point values into actual values, that is to say actually output power.

FIG. 4 schematically shows a closed control loop 400 which contains the simplified controlled system 300 according to FIG. 3. Only for reasons of the illustration is the detected mains voltage U Ne input from below into the central farm control unit 302, with regards to content, this central farm control unit 302 of FIG. 4 corresponds to that of FIG. 3 however, which is why the same reference signs are also used. A Iso, the same reference signs were otherwise used for similar elements, which should not exclude the possibility that differences in detail are nevertheless present.

FIG. 4 additionally shows another grid block 406 in the closed control loop 400, which grid block is an electrical supply grid or a section thereof or should in one example illustrate an island grid or is representative for the same. FIG. 4 therefore shows overall that a frequency-dependent power is specified by the farm control unit 302, implemented by the wind power installation 304 or a plurality of wind power installations and fed into the electrical supply grid according to grid block 406.

The electrical supply grid reacts to that and may change its mains voltage U Ne. This change can include a frequency change, which is in turn detected in the central farm control unit 302. For that, a control loop is actually present, in which or using which the electrical supply grid is controlled. The mains frequency changes as a result, which is fed back and as a result in turn affects the controlled system. In one example, it is pro-posed to take it into account that a closed control circuit is actually present here.

To check properties of such a simplified controlled system 300 according to FIG. 3 or a closed control loop 400 according to FIG. 4, a simulation set-up according to FIG. 5 is provided. In the introduction, possible frequency oscillations were described above and such frequency oscillations could in principle be overcome by damping in the con-trolled system, so the specification of a corresponding at least minimum internal damping of the controlled system may come into consideration. Therefore, it would be possible to check whether such damping is fulfilled according to a fixed schema. The simulation set-up 500 according to FIG. 5 can be used for that. This contains a central farm control unit 302 and a wind power installation 304 which together may stand representatively for a plurality of wind power installations or wind power installations of a wind farm. The reference signs are additionally chosen as in FIGS. 3 and 4, as the elements can be the same or are at least similar.

In addition, a simplified arrangement with a variable load 508 and a phase shifter 510 is chosen as electrical supply grid 506. The phase shifter 510, which can in one example, essentially designate an idling synchronous motor, in principle provides the mains voltage U Ne with the mains frequency, but does not have any damping itself. If a small synchronous motor is chosen as phase shifter, changes of the power that is fed in correspondingly have a stronger effect on the behaviour of this synchronous motor and oscillations may come about easily, as at least the phase shifter 510, that is to say the synchronous motor that is used itself, has no or no significant damping. As a result, it is therefore possible to check whether there is satisfactory inner damping in the simplified controlled system 300 which is also found again in FIG. 5.

It may also be that minimum internal damping of the controlled system, such as the controlled system 300, is desired. In order to analyze the minimum internal damping of the controlled system (e.g., of type 2 installations), a simulated scenario is proposed, which is shown in FIG. 3. In the scenario, type 2 installations are operated in a fictitious undamped island grid in parallel with variable loads and a small synchronous motor as phase shifter, as FIG. 5 shows. As, in such a fictitious simulated scenario, the loads are assumed to be voltage- and frequency-independent and the small synchronous motor is assumed to be frictionless, the controlled system of the type 2 installation, that is to say the simplified controlled system 300, remains as the only possible source for impressing the damping in this closed control loop. Therefore, an internal damping of the controlled system can be analyzed in a verification process.

In one example, it was originally also assumed for the proposed solution that previous controls for generating a frequency-dependent power specification were very weakly or even not damped. In the simulation arrangement 500 according to FIG. 5, such a simplified controlled system 300 without or with very little damping would tend to oscil-late.

FIG. 6 shows a power control loop 600 schematically and in a simplified manner. This has a frequency detection block 612 which determines a frequency or frequency devia-tion df from the detected mains voltage UNe. The frequency deviation df is a deviation from a mains nominal frequency. This frequency deviation df is passed into the low-pass filter block 614, so that the result is a frequency filter signal dfF. This is converted into a frequency-dependent set-point power portion dPS in the power control block 616. This can take place with the aid of a droop function, in which a power value is assigned to each frequency deviation from the nominal frequency. This frequency-dependent set-point power portion dPS can be limited in the limiting block 618.

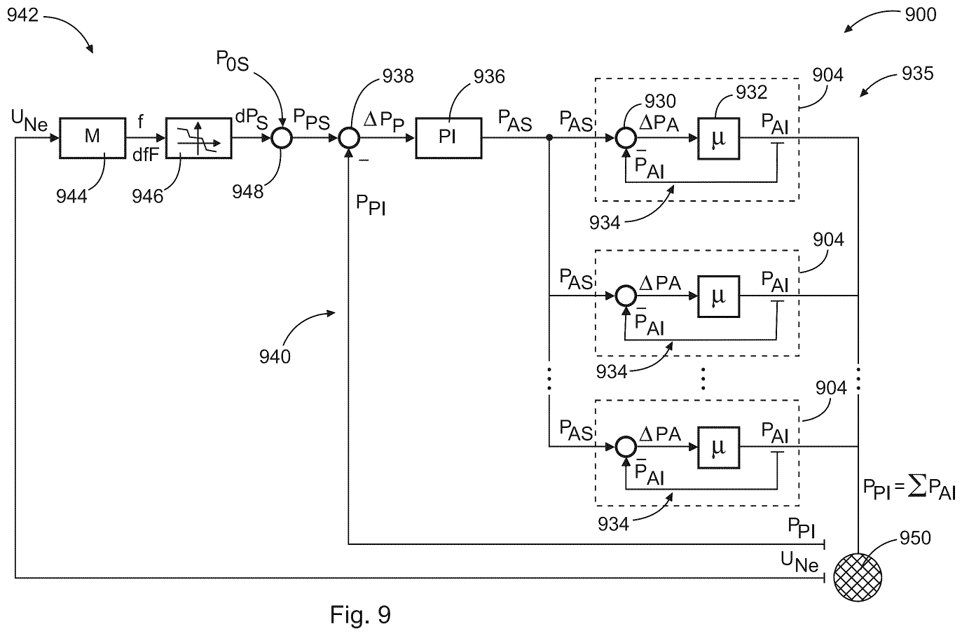

The result is then a limited set-point power portion dPSL. A set-point fundamental power portion POS can be added to this limited set-point power portion dPSL, that is in the sum-ming point 620. The result is then a farm set-point power PPS. This farm set-point power can then be processed further, which is also explained in more detail in connection with FIG. 9. It is the case in one example, that this farm set-point power PPS is compared with a farm actual power in order to determine the installation set-point power PAS depending on the same. In this case, the farm set-point power PPS can additionally be converted to a percentage value if the installation set-point power PAS is desired as a percentage value.

A power control structure 600 of this type therefore has a few dynamic elements and these also include the low-pass filter block 614. This can be set up to attempt to achieve a desired speed and also desired stability.

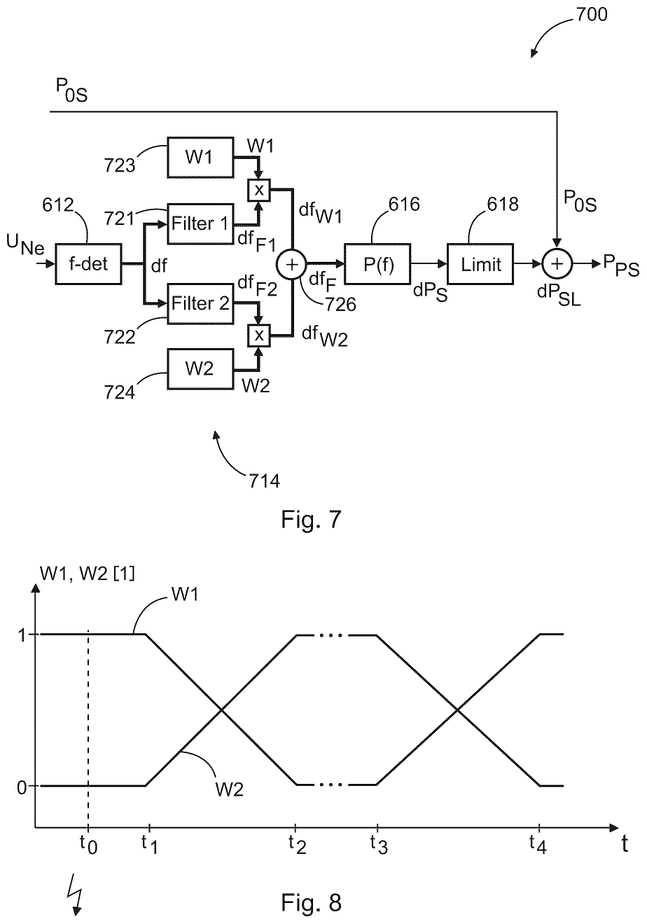

A power control structure 700 is proposed for improvement, which is shown in FIG. 7. This power control structure 700 builds on the power control structure 600 of FIG. 6. Except for the changes that are explained in the following, these two power control structures 600 and 700 can be the same and therefore the same reference signs are also used for the same or similar elements in FIG. 7 as in FIG. 6.

Instead of the frequency filter block 614, the power control structure 700 uses a filtering device 714.

The filtering device 714 has a first and a second filtering function 721 and 722. Both filtering functions 721 and 722 are in each case designed as low-pass filters. The first filtering function in this case has a smaller time constant than the second filtering func-tion 722. The first filtering function outputs a first partial filter frequency signal dfF1 and the second filtering function 722 outputs a second partial filter frequency signal dfF2.

These two partial filter frequency signals dfF1 or dfF2 are then in each case multiplied with a first or second weighting factor W1 or W2. These two weighting factors W1 and W2 are in each case generated or set in a first or second weighting block 723 or 724.

The result is a first or second weighted filter signal dfW1 or dfW2 in each case. These are added to one another at the summing point 726 and form the frequency filter signal dfF.

In principle, due to this proposed structure of the filtering device 714, it is possible to ensure that—expressed in simple terms—the frequency deviation df takes the upper or lower path. The upper path is faster and leads to a faster control result, whereas the lower path is slower and therefore more stable. As a result of the fact that the weighting factors W1 and W2 can be changed continuously, it is possible to control a fluid transition between the frequency deviation df taking the upper or the lower path.

For example, a continuous transition can be ensured by specifying a ramp function to the first and second weighting W1 and W2. The first and second weighting block 723 and 724 can specify a corresponding ramp, for which the first weighting factor W1 is for example lowered from 1 to 0 by means of a time ramp, whilst the second weighting block 724 allows the second weighting factor W2 to rise from 0 to 1 using a time ramp. If the first weighting factor W1 is equal to 1 and the second is equal to 0, then the frequency deviation only takes the route via the upper path, that is to say is filtered fast. If the first weighting factor W1 is equal to 0 and the second is 1, the frequency deviation df takes the route via the lower path and is therefore filtered more slowly.

A proposed solution can therefore be realized using the power control structure 700, for example using the filtering device 714, in which proposed solution the determined frequency is initially filtered in parallel at least using two different time constants using a low-pass filter. Preferably, one time constant is small and the other one is large.

Then an average value is ascertained from the outputs of this preceding step, that is to say the parallel filtering, wherein the outputs are weighted by different factors, namely the weighting factors W1 and W2, and in the case of more filters, correspondingly more weighting factors. If, in the example shown, both weighting factors are set to 0.5, the summing point 726 will output an arithmetic average.

Preferably, the weighting factors are adjusted over time, wherein at each time, the sum of all weighting factors is equal to 1. One possible way of adjusting the weighting factors may be such that the weighting factor of the filter with the small time constant can be chosen to be larger following the detection of a frequency disturbance. For example, is chosen to be equal to 1, and following a planned delay time, is reduced in a ramp-like manner to a minimum, in order to contribute to the stabilization of the frequency as a result.

Due to the adjustment over time of the weighting factors, it is possible to react fast at the start of a frequency disturbance, namely due to the high weighting factor of the filter with the small time constant. Thus, the criteria on the speed of adjustment of the frequency-dependent power controller can be fulfilled in a manner unaffected by the modifications for introducing the damping. According to an adjustable time or another criterion, it is possible to achieve internal damping by reducing the weighting factor of the filter with the small time constant and at the same time increasing the weighting factor of the filter with the large time constant.

One possible curve of the two weighting factors W1 and W2 is illustrated in the graph of FIG. 8.

FIG. 8 therefore shows a time graph in which a possible curve of the two weighting factors W1 and W2 is illustrated. Until a time t0, stable operation is assumed, in which feeding takes place into the electrical supply grid, which is operating in a fault-free and stable manner. At time to, a grid fault then occurs, which may cause a frequency jump for example. The grid then no longer operates in a stable manner and a risk of oscillation arises. The two weighting factors W1 and W2 are initially left unchanged, however. Thus, the situation remains that due to the weighting factor W1, the first low-pass filter with the small time constant is active and the second low-pass filter is inactive, because the second weighting factor W2 has the value 0. With this setting, a fast control behaviour is present and therefore frequency changes can also change a frequency-dependent power fast.

The end of a transition time is then awaited and then at time t1, the first weighting factor W1 is lowered to 0 with a ramp until time t2 and at the same time, the second weighting factor W2 is raised to the value 1 with a ramp until time t2. In this respect, the interval between t0 and t1 can form the transition time.

In one example, the interval between the times t1 and t2 can lie in the range from 0.1 s to 30 s, 1 s to 10 s, etc.

From the time t2, it is then initially assumed that the grid is not yet operating in a stable manner or at least instabilities and a tendency to oscillate are still to be expected. Accordingly, the partitioning with the weighting factor W1=0 and the weighting factor W 2=1 is maintained until the time t3. The time t3 may for example be 1 to 10 s following the time t2, but also up to 1 min or even up to 5 min. It is the case that the grid is observed and as long as a particular oscillation amplitude is to be noted, it is assumed that a grid is not yet entirely stable or at least has still not recovered completely.

At time t3 however, it is assumed then that the grid has recovered again and is operating in a stable manner. Then, the two weighting factors are returned to initial values again. The first weighting factor W1 can therefore be ramped up with a ramp from 0 to 1 from time t3 to time t4, whilst the second weighting factor W2 can be ramped down with a ramp from 1 to 0 from time t3 to time t4. At time t4, the first weighting factor has there-fore then reached the value 1 and the second weighting factor has reached the value 0. Stable operation is then to be assumed again from time t4.

FIG. 8 is an illustrative example in which the weighting factors W1 and W2 change between 1 and 0 or 0 and 1, that is to say between 100% and 0% or 0% and 100%. It is preferably provided however that although W1 reaches the value 1 or 100%, it does not fall down to 0, but rather only down to a small value which may be in the range from 5% to 20%, it is proposed in one example that W1 only falls to approximately 10% and correspondingly, although W2 can assume the value 0, it increases only correspondingly to a large value of 80% to 95%. With reference to the graph of FIG. 8, this means that W1 in the region between t2 and t3 assumes a small value greater than 0, for example 10%, and W2 in the region between t2 and t3 assumes a large value less than 1, for example 90%.

FIG. 9 schematically shows a cascade control structure and therefore a cascade controller 900 for a wind farm. This wind farm has diverse wind power installations 904 which are indicated here by the dashed outlines only with regards to the cascade control structure that is to be explained. Each of these wind power installations 904 outputs an installation actual power PAI, which are designated the same, even if they are not identical signals. The same is true for the remaining elements of the individual wind power installations 904.

This installation actual power PAI is corrected to an installation set-point power PAS in that the installation actual power PAI is subtracted from a specified installation set-point power PAS at a first summing element 930. The installation differential power APA results as control deviation which is passed into the installation controller 932 which controls the wind power installation such that the installation actual power PAI generated is correspondingly corrected to the installation set-point power PAS. Therefore, this feedback to the first summing element together with the installation controller 932 forms an inner control loop 934.

All of the wind power installations 904 are structured in this manner and thus have this inner control loop 934 and overall generate the farm actual power PPI which is the sum over all installation actual powers PAI. This farm actual power PPI is then fed into the electrical supply grid 950. Therefore, as a result, the farm actual power PPI is also corrected by all these inner control loops 934. The inner control loops 934 therefore also as a whole together form an inner control loop for the wind farm, which can therefore be referred to as an inner farm control loop 935.

Furthermore, a farm power controller 936 is provided, which determines the installation set-point power PAS which therefore forms a control variable for this farm power controller 936, which is passed to the wind power installation.

The farm power controller 936 receives a differential farm power ΔPP as control fault between a farm set-point power value PPS and the farm actual power value PPI. The difference is formed at the second summing element 938.

This farm power controller 936 therefore forms a further, that is middle control loop 940. It is superimposed on the inner farm control loop 935 which is formed from the inner control loops 934.

This middle control loop 940 or the farm power controller 936 receives the farm set-point power value PPS from an outer control loop 942. This outer control loop detects a mains voltage UNe using the measuring block 944 which detects the mains frequency f from that. In the measuring block 944, frequency determination takes place, but filtering and in one example the filtering device 714 according to FIG. 7 may also be contained together with the frequency detection block 612, likewise according to FIG. 7, in the measuring block 944.

The measuring block 944 can therefore ideally also output the filter frequency or the filter frequency signal dfF. This filter frequency signal dfF is then passed to the frequency-dependent power control block 946, which may contain a droop function. This droop function can form a relationship between frequency that is input and power that is to be output. The frequency-dependent power control block 946 therefore outputs a frequency-dependent set-point power portion dPS. A set-point fundamental power portion POS is also added to this at the third summing element 948. The result is the farm set-point power PPS which is forwarded to the middle control loop 940.

The inner control loops 934 of the individual wind power installations 904 can therefore be combined as inner farm control loop 935 or considered as such. To control the feed-ing-in of the electric power by means of a wind farm, a cascade controller 900 is there-fore proposed, which has the inner farm control loop 335, the middle control loop 940 and the outer control loop 942.

The outer control loop in this case comprises the measuring block 944, in which it is proposed to adjust a time constant by means of the contained filtering device 714. As a result, it is possible in a situation-dependent manner to make the outer control loop 942 slower than the middle and/or inner control loop. It may however also be provided to make the outer control loop 942 faster, for example if a stable supply grid 950 is assumed.

1. A method for feeding electric power into an electrical supply grid having a mains voltage with a mains frequency via an infeed unit, comprising:
detecting the mains frequency;
forwarding the mains frequency as a frequency measurement signal,
filtering the frequency measurement signal into a frequency filter signal using a filtering device with low-pass behaviour,
determining a frequency-dependent set-point power portion based on the frequency filter signal, and
feeding in the electric power based on the frequency-dependent set-point power portion, wherein
to filter the frequency measurement signal using the filtering device with low-pass behaviour, at least one first filtering function and one second filtering function with low-pass behaviour with a first low-pass time constant or a second low-pass time constant are used, and
the first filtering function and the second filtering function are entirely or partially interchangeable using at least one of a first weighting factor or a second weighting factor.

2. The method according to claim 1, wherein
the first filtering function and the second filtering function operate in parallel to one another,
the first filtering function and the second filtering function are weighted with the first weighting factor or second weighting factor, and
the first filtering function and the second filtering function are interchangeable by changing at least one of the first weighting factor or the second weighting factor.

3. The method according to claim 1, wherein
the first filtering function and second filtering function filter the frequency measurement signal into a first partial filter signal or a second partial filter signal,
the first partial filter signal and the second partial filter signal, weighted with the first weighting factor or the second weighting factor, are added up to form at least part of the frequency filter signal, and
the first weighting factor and the second weighting factor are changeable.

4. The method according to claim 1, wherein
the first weighting factor and the second weighting factor are only changed such that a sum of the first weighting factor and the second weighting factor remains constant.

5. The method according to claim 1, wherein
the second low-pass time constant is chosen depending on a system natural frequency of the electrical supply grid that is coupled with the infeed unit, such that the second low-pass time constant is larger than a reciprocal of the system natural frequency.

6. The method according to claim 1, wherein
the first low-pass time constants and second low-pass time constant are changeable for adapting to a system change and/or a changed system requirement, subject to the first low-pass time constant remaining smaller than the second low-pass time constants.

7. The method according to claim 1, wherein
the first low-pass time constant is smaller than the second low-pass time constant, and
in stable operation, when no grid fault has been identified or, following a grid fault,
a stable state has been reached, the first weighting factor is chosen to be greater than the second weighting factor, with the first weighting factor being set at 1 and the second weighting factor being set at 0,
in fault-case operation following an identification of the grid fault, the first weighting factor is reduced and the second weighting factor is increased, such that the first weighting factor is reduced to a value in a range from 5% to 20% and the second weighting factor is increased to a value in a range from 80% to 95%, and
following the fault-case operation, after a safety period has elapsed or after a stability criterion has been fulfilled, a return to the stable operation is carried out in that the first weighting factor is increased to 1, and the second weighting factor is reduced to 0.

8. The method according to claim 7, wherein when the first low-pass time constant is smaller than the second low-pass time constant,
in the fault-case operation following the identification of the grid fault, the first weighting factor is reduced continuously, using a time ramp function, and the second weighting factor is increased synchronously with the first weighting factor, such that the first weighting factor is reduced to a value in a range from 5% to 20% and the second weighting factor is increased to a value in a range from 80% to 95%, and
following the fault-case operation, after the safety period has elapsed or after the stability criterion has been fulfilled, a return to stable operation is initiated in that the first weighting factor is increased continuously, using the time ramp function to 1, and the second weighting factor is reduced synchronously with first weighting factor, to 0.

9. The method according to claim 1, wherein
the infeed unit is designed as a wind farm having a plurality of wind power installations, and
the filtering of the frequency measurement signal via the filtering device and the determination of the frequency-dependent set-point power portion are implemented in a central farm control unit, and a set-point power value that is to be fed in is transferred to the wind power installations depending on the frequency-dependent set-point power portion, and
the set-point power value is formed as a sum of the frequency-dependent set-point power portion and a set-point fundamental power value.

10. The method according to claim 9, wherein
the frequency-dependent set-point power portion is limited by a limiting function to a power limit in order to form a limited set-point portion, and
the limited set-point portion is added to the set-point fundamental power value to form the set-point power value for the power to be fed in, and
the set-point fundamental power value is chosen to be below an available power by the power limit, the available power being from wind, if a generation unit is a wind power installation or a wind farm.

11. The method according to claim 1, wherein
the first filtering function and the second filtering function are realized by a filtering unit from a list comprising:
a PT1 element, and
a PT2 element with a damping ratio D>1, and
an averaging unit for carrying out an ongoing averaging, and
a filter with a behaviour similar to the PT1 element or the PT2 element, and
a filtering element with a time constant and with a step response without overshoot.

12. The method according to claim 1, wherein
a wind farm with a farm control unit having a farm power controller and with a plurality of wind power installations is used for feeding in the electric power,
the wind farm has a cascade controller with three control loops, having
an inner control loop, in which each of the wind power installations is configured to adjust an output power to an installation set-point power specified by the farm power controller,
a middle control loop, in which the farm power controller is configured to (i) determine the installation power as control variable depending on a comparison between a farm set-point power value and a farm actual power value and (ii) transfer the installation power to the wind power installations as installation set-point power, and
an outer control loop, in which, depending on the mains frequency, the set-point power portion and the farm set-point power value is determined as control variable and transferred to the farm power controller, wherein
the filtering device with low-pass behaviour for filtering the frequency measurement signal is part of the outer control loop,
the second low-pass time constant, if greater than the first low-pass time constant, is chosen such that the outer control loop has a slower time response than at lest one of the middle control loop or the inner control loop if the second weighting factor is chosen to be 1 or is at least dominant compared to the first weighting factor with a value in a range of 80% to 95%,
the first low-pass time constant is chosen such that the outer control loop has no slower time response than one or more of the middle control loop and the inner control loop if the first weighting factor is chosen to be 1, or is at least dominant compared to the second weighting factor with a value in the range from 80% to 95%, and
the outer control loop, if the first filtering function and the second filtering function were to be bridged, has no slower time response than the one or more of the middle control loop and the inner control loop.

13. A device for feeding electric power into an electrical supply grid having a mains voltage with a mains frequency, wherein the device is configured to:
detect the mains frequency;
forward the detected mains frequency as frequency measurement signal,
filter the frequency measurement signal into a frequency filter signal using a filtering device with low-pass behaviour,
determine a frequency-dependent set-point power portion based on the frequency filter signal, and
feed in the electric power based on the frequency-dependent set-point power portion, wherein
to filter the frequency measurement signal using the filtering device with low-pass behaviour, at least one first filtering function and one second filtering function with low-pass behaviour with a first low-pass time constant or a second low-pass time constant are used, and
the first filtering function and the second filtering function are entirely or partially interchangeable using at least one of a first weighting factor or a second weighting factor.

14. The device according to claim 13, wherein a central control unit of the device is configured to perform steps of claim 13 for feeding the electric power.

15. The device according to claim 13, wherein the device
has a wind farm with a farm control unit having a farm power controller and with a plurality of wind power installations for feeding in the electric power,
the wind farm has a cascade controller with three control loops, having
an inner control loop, in which each of the wind power installations is configured to adjust an output power to an installation set-point power specified by the farm power controller,
a middle control loop, in which the farm power controller is configured to (i) determine the installation power as control variable depending on a comparison between a farm set-point power value and a farm actual power value and (ii) transfer the installation power to the wind power installations as installation set-point power, and
an outer control loop, in which, depending on the mains frequency, the set-point power portion and the farm set-point power value is determined as control variable and transferred to the farm power controller, wherein
the filtering device with low-pass behaviour for filtering the frequency measurement signal is part of the outer control loop,
the second low-pass time constant, if greater than the first low-pass time constant, is chosen such that the outer control loop has a slower time response than at lest one of the middle control loop or the inner control loop if the second weighting factor is chosen to be 1 or is at least dominant compared to the first weighting factor with a value in a range of 80% to 95%,
the first low-pass time constant is chosen such that the outer control loop has no slower time response than one or more of the middle control loop and the inner control loop if the first weighting factor is chosen to be 1, or is at least dominant compared to the second weighting factor with a value in the range from 80% to 95%, and
the outer control loop, if the first filtering function and the second filtering function were to be bridged, has no slower time response than the one or more of the middle control loop and the inner control loop.
